(19) United States
(12) Patent Application Publication
(10) Pub. No.: US 2011/0228401 A1
(43) Pub. Date: Sep. 22, 2011

(54) OPTICAL FILTER AND DISPLAY DEVICE

(75) Inventors: Ryusuke Fukushima, Meguro (JP); Toshiharu Oishi, Osaka (JP); Takahide Fujimoto, Osaka (JP); Hiroaki Yoshimatsu, Kawasaki (JP)

(73) Assignee: PANASONIC CORPORATION, Kadoma-shi (JP)

(21) Appl. No.: 13/128,969

(22) PCT Filed: Nov. 13, 2008
(86) PCT No.: PCT/JP2008/070676

§ 371 Date: May 12, 2011

(51) Int. Cl. G02B 1/11

(52) U.S. Cl. 359/609

(57) ABSTRACT

A body antireflection layer is provided on a display surface of a display device body. A first antireflection layer and a second antireflection layer are provided on both sides of an optical filter that is opposed to the display surface by a predetermined gap. A light-blocking screen frame layer is provided on the optical filter between a light-transmissive base and the first antireflection layer near the display surface at a peripheral area corresponding to an outer periphery of the display device body. A color difference between a position of the screen frame layer and a position of a display area of the display device body is 40 or less. A border between the display area and the screen frame layer becomes difficult to be visible, so that the optical filter can be recognized by users as an integral surface having no border over the entire surface of the optical filter.

### TECHNICAL FIELD

The present invention relates to a display device having an optical filter provided with an antireflection layer and a display device provided with the optical filter.

### BACKGROUND ART

Some of known display devices include an optical filter provided with an antireflection layer on a display surface of a plasma display panel (PDP), liquid crystal panel and the like (see, for instance, Patent Literature 1 or 2).

The display device disclosed in Patent Literature 1 includes a PDP adhered with an optical filter on a display surface thereof via an adhesion layer, the optical filter including an electromagnetic-wave shielding layer, an infrared-ray absorption layer and an antireflection layer.

Further, an optical filter plate provided with reinforced glasses on both sides thereof is oppositely disposed with the PDP at the side of the display surface via a predetermined gap, so that double imaging caused by doubly reflecting an external light by the PDP and the optical filter plate.

The device disclosed in Patent Literature 2 accommodates a PDP adhered with an antireflection layer on a display surface thereof in a housing having a decorative frame that exposes to an outside a display area through which a displayed image is visible. In other words, the decorative frame covers a periphery of the PDP so that the periphery is not visible from the outside.

Patent Literature 1 JP-A-2000-156182

Patent Literature 2 JP-A-2007-264605

### DISCLOSURE OF THE INVENTION

### Problems to be Solved by the Invention

However, though wirings of the PDP is not visible from the outside and appearance is not spoiled by covering a periphery of a PDP with a decorative plate as disclosed in Patent Literature 2, a height difference is caused between the display surface of the PDP and the decorative frame. Further, since the display area is not formed on the entire surface of the display surface considering productivity and structure, a portion that is not defined as a display area has to be concealed.

As discussed above, improvement in design freedom and appearance for eliminating the height difference and the like has been desired.

An object of the invention is to provide an optical filter that provides visual integrity and excellent appearance, and a display device provided with the optical filter.

### Means for Solving the Problems

An optical filter according to an aspect of the invention is opposed to a display surface of a display device body with a predetermined gap, the optical filter including: a thin-plate light-transmissive base; a light-blocking screen frame layer provided on a surface of the light-transmissive base opposing to the display surface at a peripheral area corresponding to an outer periphery of the display device body; and an outer antireflection layer provided on an opposite surface of the light-transmissive base opposite to the surface opposing to the display surface, in which a color difference between a reflected color at a position of the screen frame layer and a reflected color at the display surface of the display device body is 40 or less.

A display device according to another aspect of the invention includes: a display device body having a display surface; and an optical filter according to any one of claims 1 to 7, the optical filter being opposed to the display surface of the display device body with a predetermined gap.

### BRIEF DESCRIPTION OF DRAWINGS

FIG. 1 is a cross section schematically showing a display device according to an exemplary embodiment of the invention.

FIG. 2 is a cross section schematically showing a display device body and an optical filter shown in FIG. 1.

FIG. 3 is a cross section schematically showing a display device body and an optical filter according to another exemplary embodiment.

FIG. 4 is a cross section schematically showing a display device body and an optical filter according to a second exemplary embodiment.

FIG. 5 is a cross section schematically showing a display device body and an optical filter according to a third exemplary embodiment.

FIG. 6 schematically illustrates a measurement position of SCE reflected color.

FIG. 7 is a graph showing a relationship between a ratio of raters who agreed integrity and a color difference ΔE*_{ab}.

### EXPLANATION OF CODES

100 . . . display device

200 . . . housing

300 . . . display device body

310 . . . plasma display panel (PDP) body

311 . . . display surface

312 . . . body antireflection layer

400, 500, 600 . . . optical filter

410 . . . light-transmissive base

420,450 . . . screen frame layer

430 . . . first antireflection layer (inner antireflection layer)

440 . . . second antireflection layer (outer antireflection layer)

510 . . . protection color layer

610 . . . light-transmittance restraining function layer (light-transmittance restraining layer)

### BEST MODE FOR CARRYING OUT THE INVENTION

### First Exemplary Embodiment

Arrangement of Display Device

A first exemplary embodiment of the invention will be described below with reference to the attached drawings.

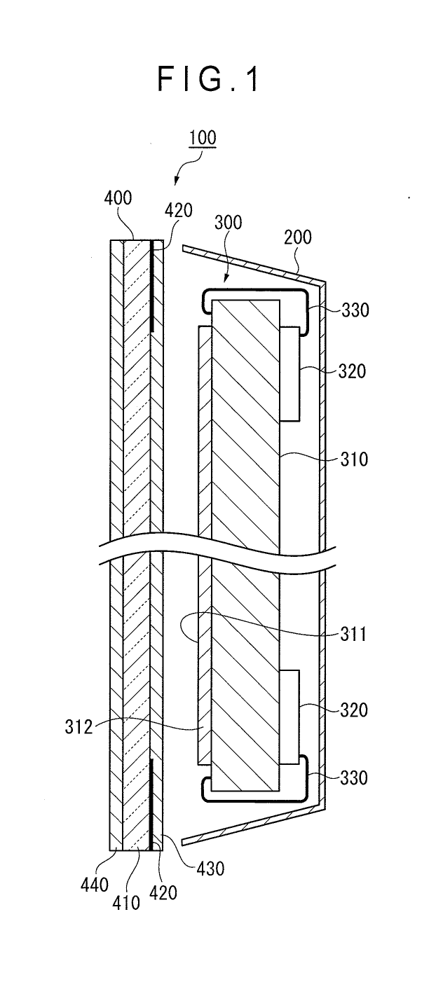

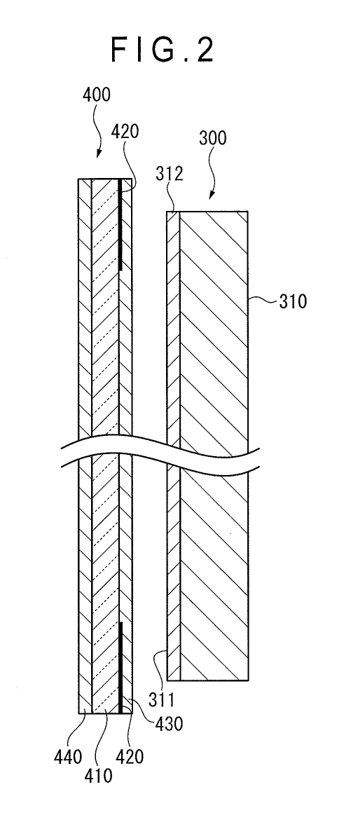

FIG. 1 is a cross section schematically showing the display device. FIG. 2 is a cross section schematically showing a display device body and an optical filter.

It should be appreciated that thicknesses of each of the components are exaggerated in FIGS. 1 and 2 for facilitating to understand the structure. Further, in FIG. 2, a component for connecting a flexible cable is not shown for the convenience of explanation.

In FIG. 1, reference numeral 100 denotes a display device. The display device 100 displays a still image and image data inputted via an input terminal (not shown)

The display device 100 includes a housing 200, a display device body 300, an optical filter 400 and the like.

The housing 200 is an approximately rectangular shallow box with a side thereof being opened. To the housing 200, the display device body 300 and an intermediate case (not shown) to which the optical filter 400 is attached is adapted to be attached.

The display device body 300 includes: a PDP body 310; a controller 320 for displaying an image on the PDP body 310; a flexible cable 330 for connecting the PDP body 310 and the controller 320 and the like.

The PDP body 310 includes a pair of substrates (not shown) that are mutually opposed via a discharge space in which inactive gas such as He—Xe (helium-xenon) series gas and Ne—Xe (neon-xenon) series gas are filled. The PDP body 310 is provided with a display surface 311 having on a first side thereof a display area on which an image is displayed.

The display surface 311 of the PDP body 310 is coated with a body antireflection layer 312 as shown in FIGS. 1 and 2. The body antireflection layer 312 can be provided by various methods such as AR (Anti-Reflection) processing and AG (Anti-Glare) processing. Incidentally, not only the body antireflection layer 312 but also an electromagnetic-wave shielding layer (a metal layer for shielding an electromagnetic wave while sufficiently transmitting visible rays), antifouling layer and color layer for blackening may be provided.

The controller 320 includes a drive circuit for controlling a displayed image (not shown), a power circuit for supplying electric power and the like.

The optical filter 400 includes a thin-plate light-transmissive base 410. The light-transmissive base 410 is provided by, for instance, glass substrate and synthetic resin plate such as acrylic plate.

A screen frame layer 420 is provided on a first side (a side opposing to the display surface 311 when being opposed to the display surface 311 of the display device body 300) of the light-transmissive base 410 in a frame shape along a periphery of the light-transmissive base 410.

When being assembled as the display device 100 as shown in FIG. 1, the screen frame layer 420 is provided at the periphery (i.e. at least from a position corresponding to a periphery of the display device body 300 to the periphery of the light-transmissive base 410). Especially, it is preferable that the screen frame layer 420 is provided at a peripheral portion extending from a position corresponding to an outermost periphery of the display area on which the image data of the PDP body 310 is displayed, to the periphery of the light-transmissive base 410.

The screen frame layer 420 contains, for instance, a black pigment and is capable of blocking light. In other words, a back side of the screen frame layer 420 is not visible. Further, the screen frame layer 420 is provided so that a color difference between a reflected color of the optical filter 400 at the position of the screen frame layer 420 and a reflected color of the display area of the display surface 311 of the PDP body 310 is 40 or less.

The color difference is defined as a difference between: an SCE reflected color of the display surface 311 of the PDP body 310 measured according to SCE (Specular Component Exclude) measurement method in accordance with condition C defined in JIS-Z-8722; and an SCE reflected color of the side (external side) viewed by a user at the position of the screen frame layer 420 of the optical filter 400 that is measured in the same manner. The screen frame layer 420 is formed to exhibit the SCE reflected color that provides the color difference of 40 or less.

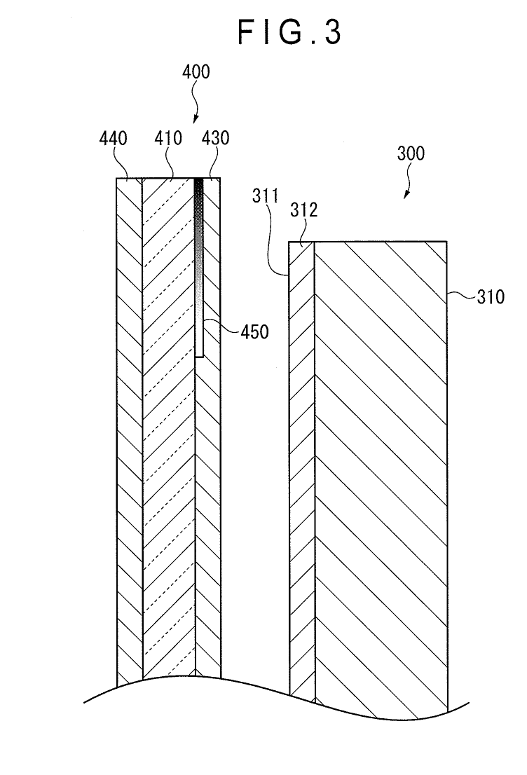

Incidentally, the screen frame layer 420 may have uniform characteristics to provide equal light-blocking properties from the outer periphery to the inner periphery. However, as in the screen frame layer 450 shown in FIG. 3, the screen frame layer 420 is preferably less light-blocking toward the inner periphery, i.e. more light-transmissive toward the inner periphery. According to the above arrangement, the display surface 311 of the display device body 300 becomes more visible toward the inner periphery of the screen frame layer 450 through the screen frame layer 450.

In order to increase the light-transmissivity toward the inner periphery, various method can be used. For instance, the content of the black pigment near the inner periphery may be reduced; the thickness is gradually reduced toward the inner periphery; or the inner periphery may be provided by a dot pattern of which diameter is gradually reduced.

Further, a first antireflection layer 430 (inner antireflection layer) is coated on the first side of the light-transmissive base 410. Incidentally, though the first antireflection layer 430 is layered on the screen frame layer 420 in terms of productivity in this exemplary embodiment, the first antireflection layer 430 may be approximately flush with the screen frame layer 420 (e.g. juxtaposed on an inner side of the screen frame layer 420).

Further, a second antireflection layer 440 (outer antireflection layer) is coated on a second side of the light-transmissive base 410.

Incidentally, the characteristics of the first antireflection layer 430 and the second antireflection layer 440 may be the same as or different from those of the body antireflection layer 312. Further, the first antireflection layer 430 and the second antireflection layer 440 may be provided by various method as in the body antireflection layer 312.

Additionally, an electromagnetic-wave shielding layer may be provided on the light-transmissive base 410.

The display device 100 is assembled by installing the display device body 300 in the intermediate case and disposing the display surface 311 to be opposed to a side of the screen frame layer 420 (the first side of the optical filter 400) via a predetermined gap. The display device body 300 is housed in the housing 200 together with the intermediate case, and the intermediate case is installed in the housing 200.

At this time, the opening periphery of the housing 200 is abutted to a periphery of the first side of the optical filter 400 so that the opening of the housing 200 is closed by the optical filter 400. In other words, the optical filter 400 and the housing 200 are assembled so that the opening periphery of the housing 200 is positioned at the position provided with the screen frame layer 420 of the optical filter 400.

Operation of Display Device

Next, an operation of the display device will be described below.

When an external light is irradiated on the display device 100, reflection of the external light at the second side (the side on which the second antireflection layer 440 is provided) of the light-transmissive base 410 is restrained by the second antireflection layer 440 of the optical filter 400. Further, the reflection of the external light transmitted through the second antireflection layer 440 and the light-transmissive base 410 at the first side of the light-transmissive base 410 is restrained by the first antireflection layer 430. Further, the reflection of the external light transmitted through the optical filter 400 at the display surface 311 of the PDP body 310 is restrained by the body antireflection layer 312. The reflection of the external light is prevented by the second antireflection layer 440, the first antireflection layer 430 and the body antireflection layer 312, so that image reflection can be prevented.

An example in which fluorescent tube used as a source of the external light irradiates an area extending over the position of the screen frame layer 420 of the optical filter 400 and the area of the display area located thereinside will be described below. In this case, when the external light reflected at the position of the display area exhibits, for instance, purple reflected color on account of the properties of the first antireflection layer 430 as compared to the external light reflected at the position of the screen frame layer 420, the external light may be visible as a purple light. However, when the second antireflection layer 440 also exhibits a purple reflected color, both of the external light reflected at the position of the screen frame layer 420 and the external light reflected at the position of the display area are visible as purple, so that color difference at the border can be prevented, thereby providing integrity.

On the other hand, the light of the image data displayed on the display surface 311 is transmitted through the body antireflection layer 312 and the optical filter 400 to be visually recognized by a user. The reflection of the light of the image data at the first side of the light-transmissive base 410 after being transmitted through the body antireflection layer 312 and the first antireflection layer 430 is restrained by the first antireflection layer 430. At the same time, the reflection of the external light reflected to be incident on the display surface is restrained by the body antireflection layer 312. The body antireflection layer 312 and the first antireflection layer 430 prevent the generation of double-imaging of the image data.

Advantages of Display Device

In the display device of the first exemplary embodiment, the body antireflection layer 312 is provided on the display surface 311 of the display device body 300; the first antireflection layer 430 and the second antireflection layer 440 are provided on both sides of the optical filter 400 opposed to the display surface 311 via a predetermined gap; and the light-blocking screen frame layer 420 is provided on the first side (facing the display surface 311) on the peripheral area corresponding to the outer periphery of the display device body 300 between the light-transmissive base 410 and the first antireflection layer 430.

Accordingly, the height difference is not generated unlike the conventional decorative frame to provide a flat surface and irregular touch between the screen (display area) and the screen frame can be eliminated, thereby providing visual integrity to users. In other words, the border between the display area of the display surface 311 of the PDP body 310 and the screen frame layer 420 of the optical filter 400 is not easily visible when the power source is OFF (i.e. the same condition as that in black-display), so that the display surface 311 can be recognized by users as an integral surface having no border over the entire surface of the optical filter 400.

Especially, the display device 100 is assembled by abutting the periphery of the housing 200 to the position at which the screen frame layer 420 of the optical filter 400 is provided, so that the housing 200 is also not visible to users, thus further effectively enhancing the integrity.

Further, the screen frame layer 420 is provided so that the color difference between the reflected color of the optical filter 400 at the position of the screen frame layer 420 and the reflected color of the display surface 311 of the PDP body 310 is 40 or less.

Accordingly, the color difference between the screen frame layer 420 and the display surface 311 is not recognizable, so that the border between the screen and the screen frame is hardly recognized, thus further enhancing the visual integrity.

Further, the first antireflection layer 430 is provided to be layered on the surface of the screen frame layer 420.

Accordingly, the first antireflection layer 430 can be printed in a superposing manner without providing in parallel on the screen frame layer 420, so that the first antireflection layer 430 can be provided in an easy process such as coating, thereby improving the productivity of the optical filter 400 that is capable of offering an integrity.

Further, the screen frame layer 420 is formed so that the transmittance is gradually increased from an outer periphery to an inner periphery thereof.

Thus, since the display surface 311 of the PDP body 310 can be seen through toward the inner periphery of the PDP body 310, the border between the screen and the screen frame becomes further blurred, thus providing further integrity and improved integrity.

### Second Exemplary Embodiment

Arrangement of Display Device

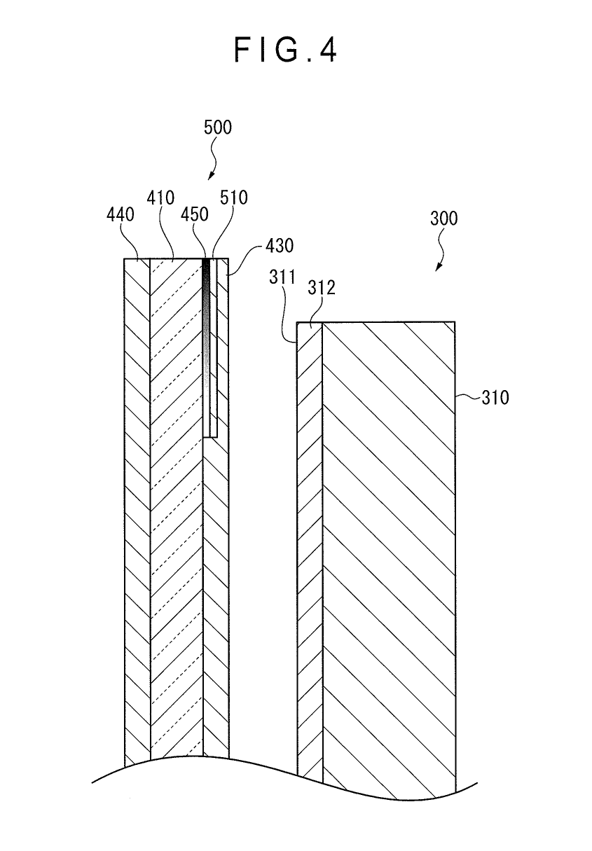

Next, a second exemplary embodiment of the invention will be described below with reference to FIG. 4.

Incidentally, in the second exemplary embodiment, the same reference numeral will be attached to the same components as those in the first exemplary embodiment to omit or simplify the description thereof.

FIG. 4 is a cross section schematically showing a display device body and an optical filter in the second exemplary embodiment.

In FIG. 4, 500 denotes an optical filter. The optical filter 500 is provided by layering a protection color layer 510 on the screen frame layer 450 shown in FIG. 3 (the first exemplary embodiment), in which the transmittance of the screen frame layer 420 is increased toward the inner periphery thereof.

The protection color layer 510 is provided by mixing a pigment so that the color thereof becomes the same as or similar to the color of the display area of the display surface 311 of the PDP body 310 when the power is OFF. The protection color layer 510 can be provided by blending and mixing the pigment to have a color identical with or similar to the color of the display area of the display surface 311 of the PDP body 310 in the same manner as, for instance, the screen frame layer 420.

Incidentally, a part of the protection color layer 510 may extend beyond the inner periphery of the screen frame layer 420 toward further inner side.

Operation of Display Device

Next, an operation of the display device will be described below.

When the power is OFF, the screen frame layer 450 increases the transmittance toward the inner periphery. Accordingly, the overlaid protection color layer 510 can be seen through the screen frame layer 450 toward the inner periphery.

Further, since the color of the protection color layer 510 and the color of the display area of the PDP body 310 located inward relative to the protection color layer 510 are identical with or similar to each other, though there is a difference in distance between the position of the protection color layer 510 and the position of the display surface 311 of the PDP body 310, the border becomes blurred. In addition, since the black color of the outer screen frame layer 450 gradually becomes similar to the color of the display surface 311 (charcoal verging on black), further visual integrity between the screen and the screen frame can be provided.

Advantages of Display Device

According to the display device according to the second exemplary embodiment, in addition to the arrangement of the above-described first exemplary embodiment, the protection color layer 510 is layered on the screen frame layer 450 that increases transmittance thereof toward the inner periphery, the protection color layer 510 having a color identical with or similar to the color of the display area of the PDP body 310 when the power is OFF.

Accordingly, since the color gradually becomes close to the color of the display surface 311 from the outside, further visual integrity between the screen and the screen frame can be provided.

### Third Exemplary Embodiment

Arrangement of Display Device

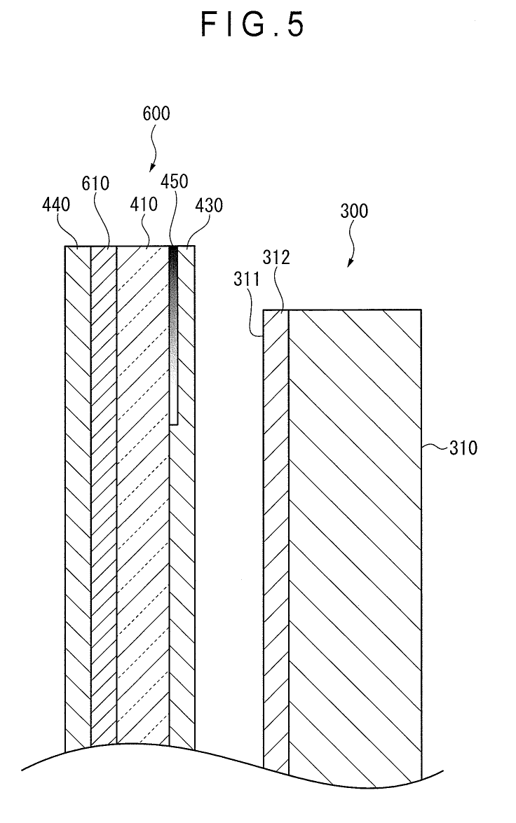

Next, a third exemplary embodiment of the invention will be described below with reference to FIG. 5.

Incidentally, in the third exemplary embodiment, the same reference numeral will be attached to the same components as those in the first exemplary embodiment to omit or simplify the description thereof.

FIG. 5 is a cross section schematically showing a display device body and an optical filter in the third exemplary embodiment.

In FIG. 5, 600 denotes an optical filter. The optical filter 600 is provided by layering a light-transmittance restraining function layer 610 on the screen frame layer 450 shown in FIG. 3 (the first exemplary embodiment), in which the transmittance of the screen frame layer 420 is increased toward the inner periphery thereof.

The light-transmittance restraining function layer 610 is thinly provided between the light-transmissive base 410 and the second antireflection layer 440. The light-transmittance restraining function layer 610 contains, for instance, a pigment and is capable of restraining the light transmissivity (light-transmittance restraining function). The light-transmittance restraining function layer 610 is provided by various methods such as coating, vapor deposition and adhesion.

The light-transmittance restraining function layer 610 is preferably formed to exhibit, for instance, a total light transmittance in a range from 20 to 80%. When the total light transmittance is lower than 20%, the displayed image data may be too dark to provide an excellent display condition. On the other hand, when the total light transmittance exceeds 80%, the border between the screen and the screen frame becomes easily visible so that an integrity between the screen and the screen frame is not easily obtained. Thus, the total light transmittance is preferably set in a range from 20 to 80%.

Incidentally, though the light-transmittance restraining function layer 610 is exemplified by an arrangement having the screen frame layer 450 of which transmittance increases toward the inner periphery thereof, the light-transmittance restraining function layer 610 may be applied to an arrangement having the screen frame layer 450 in the first exemplary embodiment or an arrangement having the protection color layer 510.

Further, the light-transmittance restraining function layer 610 may exhibit a near-infrared-ray absorption function for restraining the transmission of infrared rays, neon-emission absorption function for restraining the transmission of neon (Ne) emission or may be provided as a composite layer exhibiting the combination of the functions. Alternatively, the light-transmittance restraining function layer 610 may be provided by a layered structure in which infrared-ray-absorption function layer and Ne-cut function layer are layered.

Operation of Display Device

Next, an operation of the display device will be described below.

The external light reflected at the position of the screen frame layer 450 of the optical filter 600 and the external light transmitted through the optical filter 600 to be reflected by the display surface 311 are respectively partially blocked by the light-transmittance restraining function layer 610 before being viewed by a user.

Thus, the border between the screen and the screen frame is blurred to provide a visual integrity.

Further, the light-transmittance restraining function layer 610 is provided opposite to the PDP body 310 relative to the light-transmissive base 410, in other words, outward relative to the light-transmissive base 410.

Thus, even when being used for the PDP body 310 that especially emits much amount of heat, the influence of the heat is reduced, so that degradation can be prevented and light-transmission restrain function can be stably provided for a long time.

Advantages of Display Device

According to the display device of the third exemplary embodiment, in addition to the arrangement of the first exemplary embodiment, the light-transmittance restraining function layer 610 for restraining the light transmission is provided between the light-transmissive base 410 and the second antireflection layer 440.

Thus, the border between the screen and the screen frame becomes blurred to provide a visual integrity. Further, even when being used for the PDP body 310 that especially emits much amount of heat, the influence of the heat is reduced, so that degradation can be prevented and light-transmission restrain function can be stably provided for a long time.

### Modification of Exemplary Embodiment

It should be understood that the scope of the present invention is not limited to the above-described exemplary embodiments but includes modifications below as long as the modifications are compatible with the invention.

Specifically, though the display device body 300 exemplarily includes the PDP body 310, the present invention is applicable to various display devices such as liquid crystal display (LCD), electroluminescence (EL) panel, SED (Surface-conduction Electron-emitter Display), CRT (Cathode-Ray Tube) and rear projection display (RPJ).

Though the color difference between the screen frame layers 420, 450 and the display surface 311 is preferably 40 or less, the color difference may be defined at other values.

Further, the screen frame layers 420, 450 may be provided with a character or a figure such as a logo and character representation on the light-transmissive base 410.

The specific arrangements and processes in implementing the invention may be altered as long as the alteration is compatible with the invention.

### Advantage of Embodiment

In the above exemplary embodiment, the second antireflection layer 440 is provided on an outer surface of the optical filter 400 opposed to the display surface 311 of the display device body 300 via a predetermined gap; and the light-blocking screen frame layer 420 is provided on the optical filter 400 near the display surface 311 at the peripheral area corresponding to the outer periphery of the display device body 300. Further, the color difference between the reflected color of the optical filter 400 at the position of the screen frame layer 420 and the reflected color of the display area of the display surface 311 of the PDP body 310 is 40 or less.

Thus, there is no height difference as that caused by the conventional decorative frame (i.e. a flat surface is provided), and the color difference between the display area of the display surface 311 of the display device body 300 and the screen frame layer 420 of the optical filter 400 is not easily visible when the power source is OFF, so that the display surface 311 can be recognized by users as an integral surface having no border over the entire surface of the optical filter 400, thereby providing a visual integrity to the users.

### EXAMPLES

Examples conducted for evaluating the integrity using various optical filters and PDP bodies will be described below.

### Details of Experiment

The PDP bodies 310 and the optical filters 400 applied with various antireflection treatments were assembled with a predetermined gap as display devices, which were subjected to a sensory evaluation for visual integrity of the screen and the screen frame.

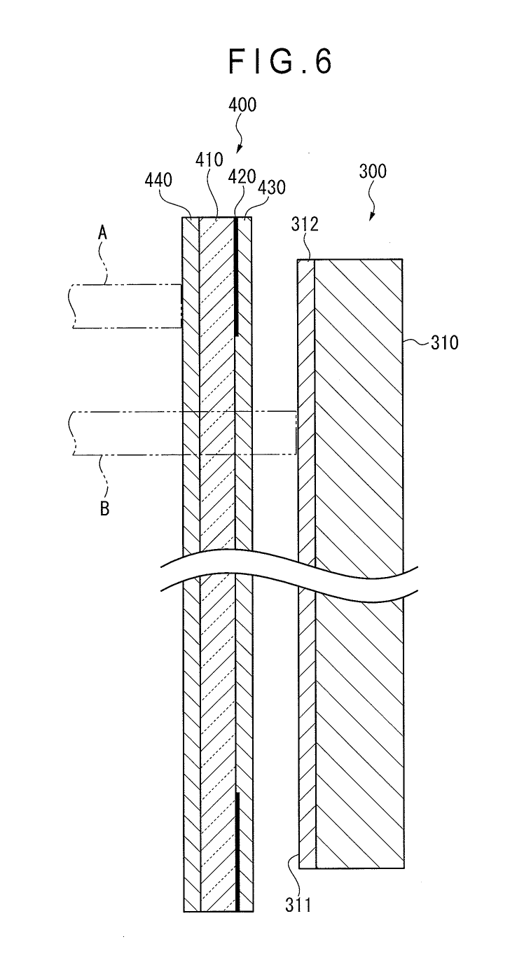

The SCE reflected color of the screen frame layer 420 of the PDP body 310 and the optical filter 400 was measured as the SCE reflected color at positions A, B shown in FIG. 6 according to condition C of JIS-Z-8722 by an SCE measurement method before being assembled in the display device 100. A spectroscopic colorimeter (product name: CM-2002) manufactured by Konica Minolta Holdings, Inc. was used for the measurement.

Then, according to values of color space colorimetric value (L*, a*, b*) of the measured SCE reflected color, the color difference AE*_{ab} was calculated according to the formula below.

ΔE*_{ab}={(L₁*−L₂*)²+(a₁*−a₂*)²+(b₁*−b₂*)²}^{1/2} (Formula)

Then, the integrity between the screen and the screen frame was observed by ten raters and the presence of the integrity was evaluated.

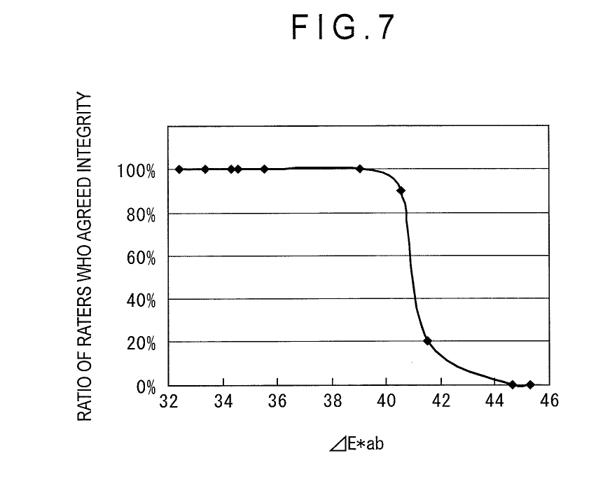

The measurement results are shown in Table 1. FIG. 7 is a graph showing a relationship between a ratio of raters who agreed integrity and the color difference ΔE*_{ab}.

TABLE 1

| | Screen frame | | | Screen frame | | | |
|---|---|---|---|---|---|---|---|
| | (measurement | | | (measurement | | | |
| | position A in FIG. 6) | | | position B in FIG. 6) | | | |
| | L* | a* | b* | L* | a* | b* | ΔE*_{ab} |
| Example 1 | 2.7 | 0.2 | −3.1 | 34.2 | −2.1 | 4.2 | 32.4 |
| Example 2 | 1.6 | 0.2 | −2.5 | 34.2 | −2.1 | 4.2 | 33.4 |
| Example 3 | 1.3 | 0.8 | −5.1 | 34.2 | −2.1 | 4.2 | 34.3 |
| Example 4 | 2.7 | 0.2 | −3.1 | 36.7 | −2.3 | 2.6 | 34.6 |
| Example 5 | 1.6 | 0.2 | −2.5 | 36.7 | −2.3 | 2.6 | 35.6 |
| Example 6 | 3.3 | −0.3 | −2.2 | 41.9 | −2.6 | 2.9 | 39.0 |
| Reference | 2.2 | 0.5 | −4.6 | 41.9 | −2.6 | 2.9 | 40.5 |
| Example 1 | | | | | | | |
| Reference | 1.3 | 0.8 | −5.1 | 41.9 | −2.6 | 2.9 | 41.5 |
| Example 2 | | | | | | | |
| Reference | 4.9 | −0.4 | −4.0 | 49.5 | −0.9 | −2.2 | 44.6 |
| Example 3 | | | | | | | |
| Reference | 4.9 | −0.4 | −4.0 | 48.9 | −1.1 | 6.7 | 45.3 |
| Example 4 | | | | | | | |

### Result of Evaluation

As shown in FIG. 7, an example having a color difference ΔE*_{ab} of 40.5 (reference example 1) was rated as lacking integrity by one of the ten raters. It was confirmed that the integrity was lost in accordance with increase in the color difference ΔE*_{ab}.

The results shown in FIG. 7 reveal that, by setting the color difference ΔE*_{ab} .at 40 or less, the display device 100 that has an integrity between the screen and the screen frame can be provided.

1. An optical filter that is opposed to a display surface of a display device body with a predetermined gap, the optical filter comprising:
a thin-plate light-transmissive base;
a light-blocking screen frame layer provided on a surface of the light-transmissive base opposing to the display surface at a peripheral area corresponding to an outer periphery of the display device body; and
an outer antireflection layer provided on an opposite surface of the light-transmissive base opposite to the surface opposing to the display surface, wherein
a color difference between a reflected color at a position of the screen frame layer and a reflected color at the display surface of the display device body is 40 or less.

2. The optical filter according to claim 1, further comprising:
an inner antireflection layer provided on an area on a side of the light-transmissive base opposed to the display surface extending over the screen frame layer or on an area inside the screen frame layer.

3. The optical filter according to claim 1, wherein
the screen frame layer is formed so that a transmittance thereof is gradually increased from an outer periphery to an inner periphery of the screen frame layer.

4. The optical filter according to claim 2, wherein
the screen frame layer is formed so that a transmittance thereof is gradually increased from an outer periphery to an inner periphery of the screen frame layer, and
a protection color layer is layered on the screen frame layer near the display surface, the protection color layer exhibiting a color identical with or similar to a color of the display surface when the display device body is not lit.

5. The optical filter according to claim 1, further comprising:
a light-transmission restraining layer for restraining a transmission of a light, the light-transmission restraining layer being provided between the light-transmissive base and the outer antireflection layer.

6. The optical filter according to claim 1, further comprising:
a near-infrared-ray absorption layer for absorbing infrared rays, the near-infrared-ray absorption layer being provided between the light-transmissive base and the outer antireflection layer.

7. The optical filter according to claim 1, further comprising:
a neon-emission blocking layer for restraining a transmission of neon, the neon-emission blocking layer being provided between the light-transmissive base and the outer antireflection layer.

8. A display device, comprising:
a display device body having a display surface; and
an optical filter according to claim 1, the optical filter being opposed to the display surface of the display device body with a predetermined gap.

9. The display device according to claim 8, further comprising:
a housing that houses the display device body so that the display surface is visible from an outside, the optical filter being attached to the housing so that a periphery of the housing is located at a peripheral area of the optical filter at which the screen frame layer of the optical filter is provided.

10. The display device according to claim 8, wherein
an antireflection processing is applied on the display surface of the display device body.

11. The display device according to claim 10, wherein
the antireflection processing applied on the display surface at least covers an area extending from a position corresponding to an inner periphery of the screen frame layer of the optical filter toward an outer periphery of the screen frame layer.

12. The display device according to claim 8, wherein
the display device body is a plasma display panel.
